(19) United States
(12) Patent Application Publication
(10) Pub. No.: US 2010/0115171 A1
(43) Pub. Date: May 6, 2010

(54) MULTI-CHIP PROCESSOR

(75) Inventors: Takanobu Tsunoda, Kokubunji (JP); Nobuhiro Chihara, Kokubunji (JP)

Correspondence Address: MILES & STOCKBRIDGE PC, 1751 PINNACLE DRIVE, SUITE 500, MCLEAN, VA, 22102-3833, US

(73) Assignee: HITACHI, LTD

(21) Appl. No.: 12/608,378

(22) Filed: Oct. 29, 2009

(30) Foreign Application Priority Data
Oct. 30, 2008 (JP) JP2008-279059

(51) Int. Cl. G06F 13/36

(52) U.S. Cl. 710/309

(57) ABSTRACT

Provided is a multiprocessor configured by stacking a plurality of unit chips each having, at least, a processor core and a memory, and the unit chip has a configuration including: a plurality of processor cores; a plurality of memories; a construction controlling unit setting connection relations between the processor core and the memory and between the processor core and the outside of the chip; and a chip connecting unit transmitting transaction between the processor, the memory, or the construction controlling unit and another stacked unit chip to be connected. The chip connecting units are arranged so as to be rotationally symmetric to each other on side portions of the unit chip, so that any of the unit chips configured by stacking is rotationally connected.

### CROSS-REFERENCE TO RELATED APPLICATION

The present application claims priority from Japanese Patent Application No. JP 2008-279059 filed on Oct. 30, 2008, the content of which is hereby incorporated by reference into this application.

### TECHNICAL FIELD OF THE INVENTION

The present invention relates to a multi-chip processor in which a plurality of processors are interconnected. More particularly, a feature of the present invention is to divide a whole processor into fundamental units whose function and connection can be changed and to restructure the plurality of fundamental units so as to achieve a processor having a desired topology.

### BACKGROUND OF THE INVENTION

Along with spread of personal computers or various digital apparatuses as information processing platforms, volume explosion of multimedia data to be a processing target has been grown into a serious problem. Computing performance required for a microprocessor and/or an embedded processor being a main component of achieving these platforms has been also significantly increased. On the other hand, processor vendors have sequentially launched high-end processors having high performance but needs large power consumption into market by diverting the scaling effect obtained by microfabrication of manufacture process mainly to improvement of operation frequency for a long time.

However, due to social trends such as improvement of users' environmental consciousness or boost of requirement for power saving technologies imposed on apparatuses, and due to technical restriction of apparatuses on thermal design along with increase of heat density of a processor chip, such a tendency that the power consumption of the processor limits the improvement of the computing performance has been becoming significant in these years.

Therefore, a current method of achieving high performance has been moved from “high-frequency achievement” of driving relatively a small number of computing elements (processor cores) at high speed to “multi-core achievement” of driving a lot of processor cores in parallel and at low speed. Along with this, there has been required an elemental technology for achieving a computing environment having high computing performance per power consumption (performance per power) and being performance scalable.

Incidentally, as means for the multi-core achievement of processors by integrating a lot of element circuits such as a processor, a memory, and various input/output interfaces, there has not been generally used a technique of integrating the whole processors on one chip but used a technique of, for example, multi-chip module (MCM) of achieving the system by wire-connecting a plurality of chips being independent in each element circuit upon package sealing.

As one example of a technique of a multi-core processor, there is Japanese Patent Application Laid-Open Publication No. 2004-164455 (Patent Document 1).

### SUMMARY OF THE INVENTION

While the above-described multi-chip module technique is particularly effective to achieve a system LSI of small lot at a low cost, usage of the multi-chip module technique in a point of view of its performance scalability or its system restructure has not been tried yet.

A preferred aim of the present invention is to achieve an embedded multiprocessor system at a low cost and in a short TAT, the embedded multiprocessor system having features of a scalable computing performance by setting the number of processor cores to be variable and an inter-processor-core connection topology capable of restructuring by having a high flexibility.

For solving the above-described problems, a multi-chip processor of the present invention is configured by stacking a plurality of unit chips each having, at least, processor cores and memories. The unit chip has a configuration including: a plurality of processor cores; a plurality of memories; a configuration controlling unit for setting connection relations among the processor cores, the memories, and the outside of the chip; and a chip connecting unit for transmitting transaction between the processor core, the memory, or the configuration controlling unit and another unit chip stacked thereon to be connected. The chip connecting units are arranged so as to be symmetrically rotated from each other on side portions of the unit chip, so that any of the unit chips configured by stacking is rotationally connected.

More specifically, the chip connecting unit is configured with: a first connecting unit for transmitting transaction between the outside of the chip and the processor core or the memory; and a second connecting unit for transmitting transaction between the outside of the chip and the configuration controlling unit, and the first connecting unit is arranged on each side portion of the processor core and the memory so as to transmit the transaction between the outside of the chip and any of the processor cores or the memories, and the second connecting unit is arranged on each side portion of the chips so as to transmit transaction between the configuration controlling unit and the outside of the chip.

According to the present invention, a scalable embedded multiprocessor system is achieved by three-dimensionally stacking fundamental unit chips each being capable of selecting a computing function of a processor and restructuring an inter-processor-core connection so as to have a desired topology. At this time, since it is not required to redesign the whole system, effects of low cost and short TAT can be obtained.

### BRIEF DESCRIPTIONS OF THE DRAWINGS

FIG. 1 is a diagram illustrating a configuration of a fundamental unit (FU) according to an embodiment of the present invention;

FIG. 2 is a diagram illustrating one example of definitions for a format of a configuration word and operation content thereof;

FIG. 3 is a diagram illustrating an example of a function configuration of the fundamental unit (FU);

FIG. 4 is a diagram illustrating an example of a chip layout of the fundamental unit (FU);

FIG. 5 is a diagram illustrating a configuration of a connection region;

FIG. 6 is a diagram illustrating another configuration of the connection region;

FIG. 7 is a diagram illustrating a configuration example of a multiprocessor system;

FIG. 8 is a diagram illustrating concept of the multiprocessor system;

FIG. 9 is a diagram illustrating a configuration example of an interconnect; and

FIG. 10 is a diagram illustrating another configuration example of the interconnect.

### DESCRIPTIONS OF THE PREFERRED EMBODIMENTS

Hereinafter, preferred embodiments of a multiprocessor system and a configuration method thereof according to the present invention will be described with reference to the accompanying drawings. Although not particularly limited, a fundamental unit chip configuring a multiprocessor system according to the present embodiments is formed on a semiconductor substrate made of single crystal silicon or silicon-on-insulator (SOI) by a technique of a semiconductor integrated circuit such as well-known CMOS transistor or bipolar transistor.

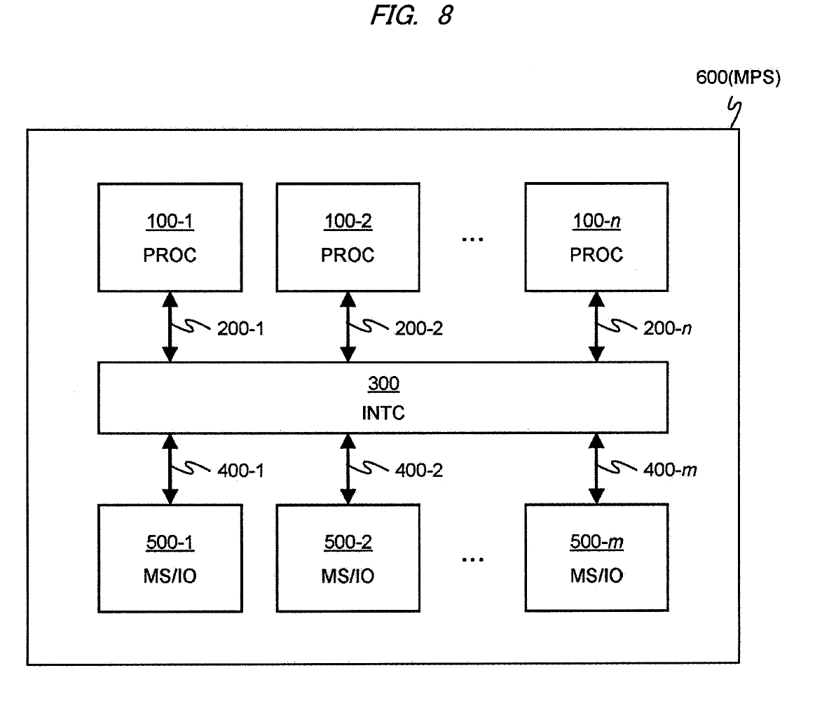

First, a system configuration of a multiprocessor system of the embodiment will be described. FIG. 8 conceptually illustrates a multiprocessor system 600 (MPS). The multiprocessor system 600 has: processor groups 100-1 to 100-n (PROC) executing a determined computing processing in accordance with a program; main storage/input-output groups 500-1 to 500-m (MS/IO) storing a program and/or data or controlling input/output to/from the outside of the system; and an interconnect 300 (INTC) controlling interconnection between the processor groups 100-1 to 100-n and the main storage/input-output groups 500-1 to 500-m via connecting interfaces 200-1 to 200-n and 400-1 to 400-m, respectively.

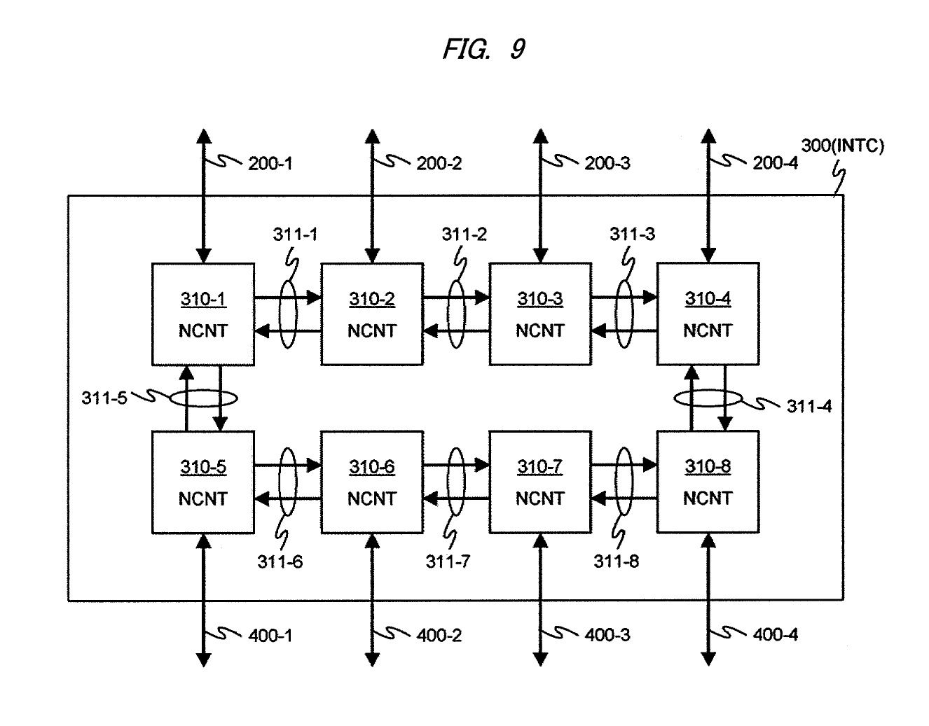

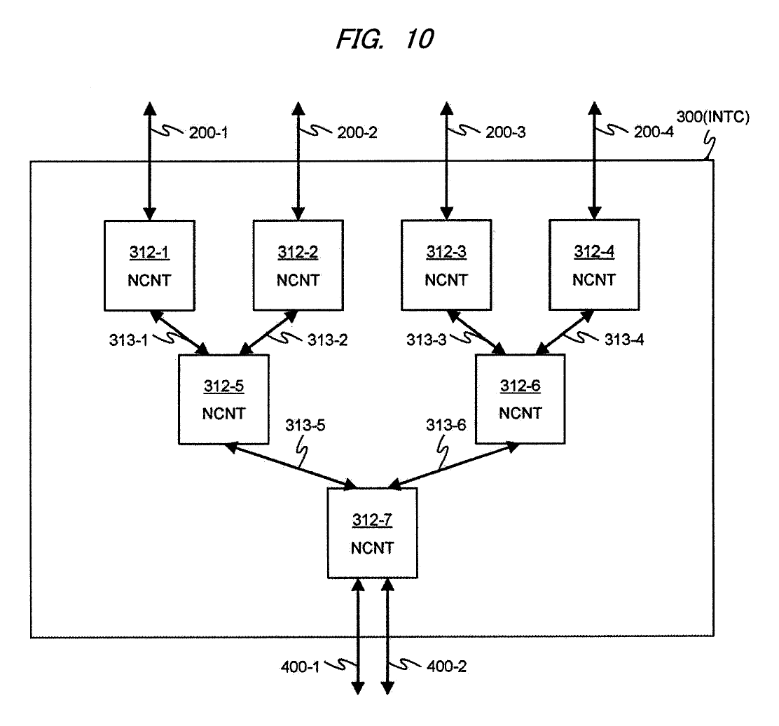

FIGS. 9 and 10 illustrate first and second configuration examples of the interconnect 300 (INTC), respectively. In FIG. 9, connection point controlling circuits 310-1 to 310-8 (NCNT) controlling transaction flow are interconnected via connecting interfaces 311-1 to 311-8 in a ring. Each of the connection-point controlling circuits 310-1 to 310-8 responses to transaction input having a determined format, identifies an address of the transaction, and outputs the transaction via a proper connecting interface to each address.

In FIG. 10, similarly, connection-point controlling circuits 312-1 to 312-7 (NCNT) controlling transaction flow are interconnected via connecting interfaces 313-1 to 313-6 in a binary tree. Generally, topology of the interconnect is fixedly optimized so as to maximize the processing performance of an application mainly executed on the multiprocessor system.

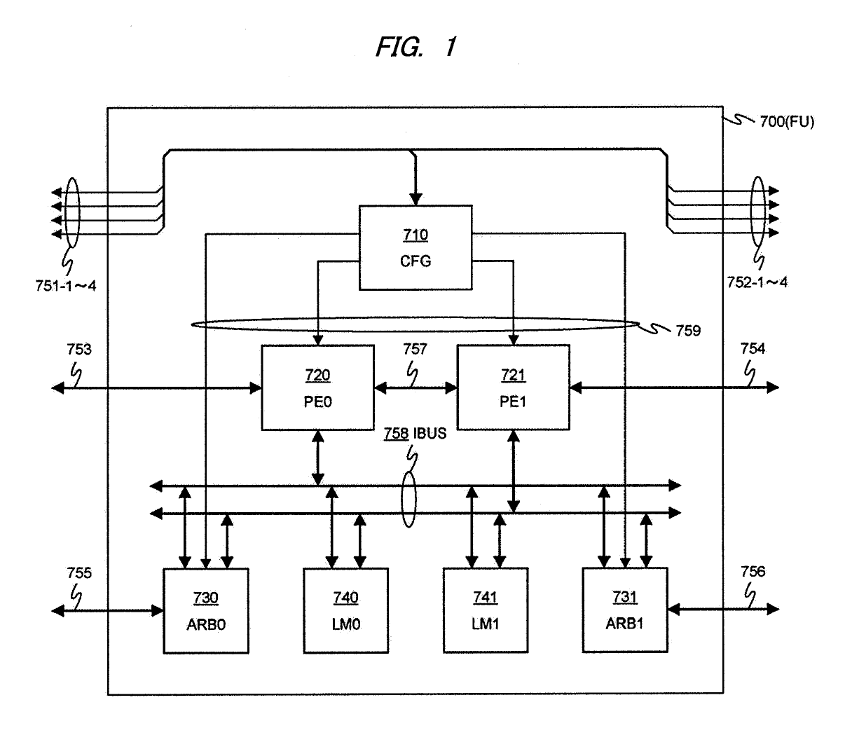

FIG. 1 illustrates an example of a fundamental unit 700 (FU) according to the present invention. The fundamental unit 700 has: processor elements 720 and 721 (PE0 and PE1) executing a determined processing in accordance with a program and a configuration signal 759; local memories 740 and 741 (LM0 and LM1) each having a unique address space and storing program and/or data; an internal bus 758 (IBUS) interconnecting between the processor elements 720 and 721 and the local memories 740 and 741; bus arbitrating units 730 and 731 (ARB0 and ARB1) transmitting the transactions between the outside of the fundamental unit and the processor elements 720 and 721 and between the outside of the fundamental unit and the local memories 740 and 741, in addition to arbitrating transactions on the internal bus 758 and between the internal bus 758 and the outside of the fundamental unit in accordance with the configuration signal 759; and a configuration controlling unit 710 outputting the configuration signal 759.

The processor elements 720 and 721 are directly connected to each other by an internal connection interface 757, and further, mutually transmit the transaction between themselves and the outside of the fundamental unit via external connection interfaces 753 and 754, respectively. The bus arbitrating units 730 and 731 also include external connection interfaces 755 and 756, respectively, similarly to the processor elements, and transmit the transaction between themselves and the inside/outside of the fundamental unit.

The configuration controlling unit 710 is a most characteristic component in the present embodiment. The configuration controlling unit 710 responses to predetermined configuration controlling signals inputted from the configuration interfaces 751-1 to 751-4 and 752-1 to 752-4 for the fundamental unit outside, and generates the configuration signal 759 determining operation contents of the processor elements 720 and 721 and the bus arbitrating units 730 and 731.

Note that, although not particularly limited, the configuration controlling unit 710 includes means for retaining one or more configuration words therein arbitrarily determining the configuration signal 759. Further, although not particularly limited, the configuration interfaces 751-1 to 751-4 and 752-1 to 752-4 are connected in parallel in predetermined regions of four sides and front and back of a semiconductor chip achieving respective fundamental units.

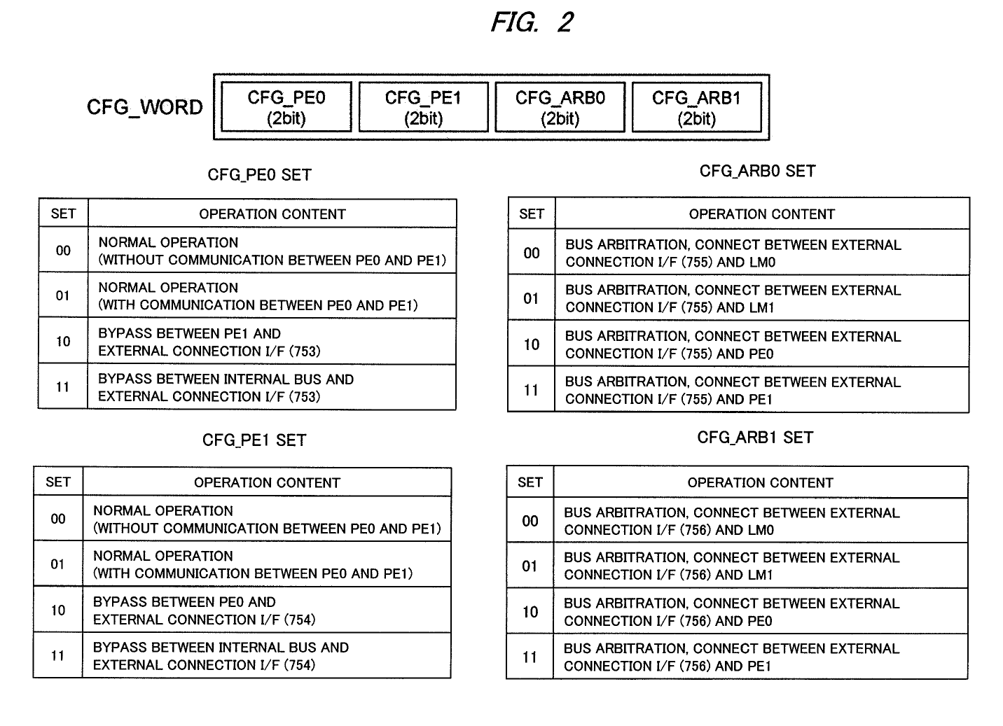

Next, a main component and a physical implementation of the fundamental unit 700 will be described in detail. FIG. 2 illustrates a format of a configuration word CFG_WORD retained in the configuration controlling unit 710, its set values, and definition examples of its operation contents. The configuration word CFG_WORD is formed of 2-bit subregions CFG_PE0, CFG_PE1, CFG_ARB0, and CFG_ARB1 whose values can be independently set.

The subregion CFG_PE0 defines the operation content of the processor element 720 (PE0). When the set value is “00” or “01”, the processor element 720 executes (normally operates) a predetermined processing such as an OS or a user program stored in the local memory 740 (LM0) or 741 (LM1), and also can express presence or absence of the transaction transmission (communication) between processor elements if needed. When the set value is “10” or “11”, the processor element 720 does not normally operate but executes bypasses of the transaction among the internal connection interface 757, the external connection interface 755, and the external connection interface 753.

The subregion CFG_PE1 defines the operation content of the processor element 721 (PE1). When the set value is “00” or “01”, the processor element 721 executes (normally operates) a predetermined processing such as an OS or a user program stored in the local memory 740 (LM0) or 741 (LM1), and also can express presence or absence of the transaction transmission (communication) among the processor elements if needed. When the set value is “10” or “11”, the processor element 721 does not normally operate but executes bypasses of the transaction among the internal connection interface 757, the external connection interface 756, and the external connection interface 754.

The subregion CFG_ARB0 defines the operation content of the bus arbitrating unit 730 (ARB0). When the set value is “00” or “01”, the bus arbitrating unit 730 transfers a transaction from the external connection interface 755 to the local memory 740 (LM0) or 741 (LM1), respectively, and besides, transfers a response transaction generated on the local memory side to the external connection interface 755. When the set value is “10” or “11”, the bus arbitrating unit 730 transfers the transaction from the external connection interface 755 to the processor element 720 (PE0) or 721 (PE1), respectively, and besides, transfers a response transaction generated on the processor element side to the external connection interface 755. Note that an arbitrating operation of the transaction on the internal bus 758 is executed regardless of the set values.

The subregion CFG_ARB1 defines the operation content of the bus arbitrating unit 731 (ARB1). When the set value is “00” or “01”, the bus arbitrating unit 731 transfers a transaction from the external connection interface 756 to the local memory 740 (LM0) or 741 (LM1), respectively, and besides, transfers a response transaction generated on the local memory side to the external connection interface 756. When the set value is “10” or “11”, the bus arbitrating unit 731 transfers the transaction from the external connection interface 756 to the processor element 720 (PE0) or 721 (PE1), respectively, and besides, transfers a response transaction generated on the processor element side to the external connection interface 756. Note that an arbitrating operation of the transaction on the internal bus 758 is executed regardless of the set values.

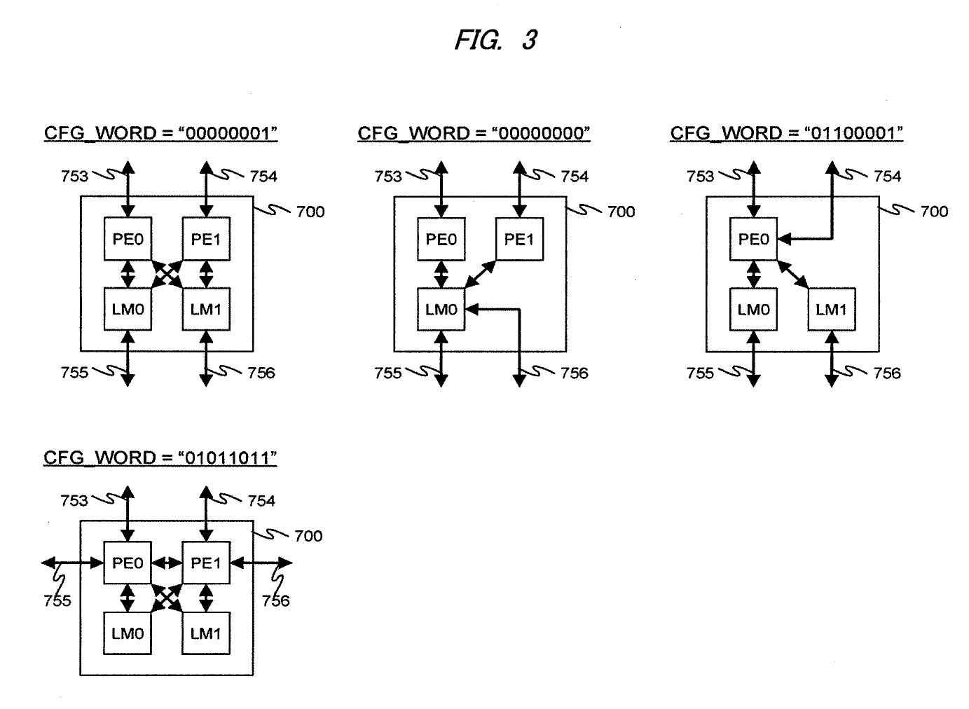

FIG. 3 schematically illustrates the settings of the typical configuration word CFG_WORD and functions of the fundamental unit 700 (FU) corresponding to respective set values.

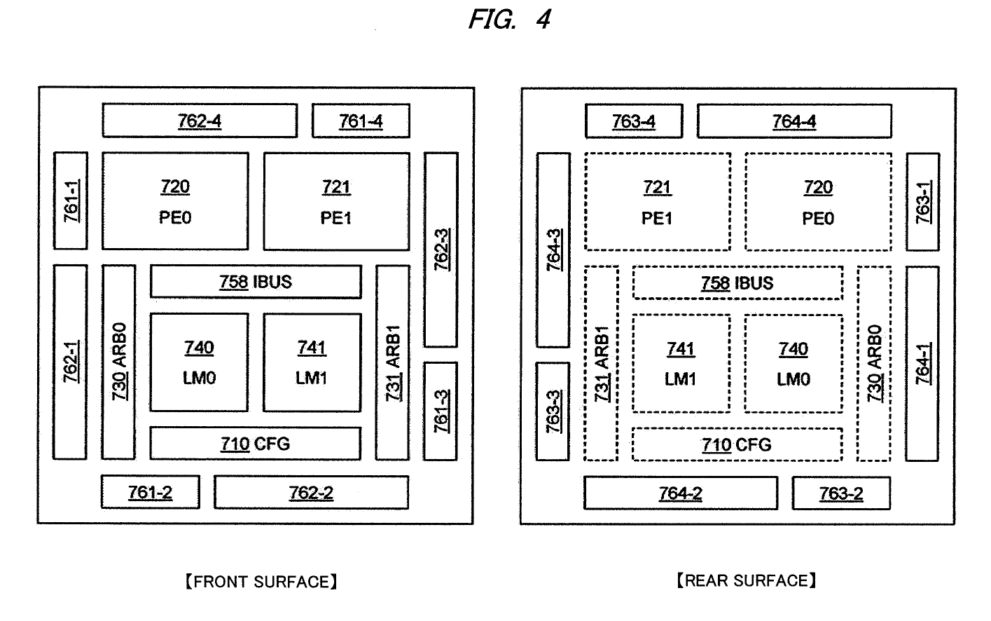

FIG. 4 schematically illustrates a layout of a fundamental unit chip in which the fundamental unit 700 (FU) is formed on a semiconductor substrate. Although not particularly limited, the fundamental unit chip has a square shape or a shape close to a square shape, and the main components of the fundamental unit illustrated in FIG. 1 including the processor elements 720 and 721 and others are formed in regions denoted by the same numeral symbols in the center portion of the fundamental unit chip.

In peripheral portions of sides of the chip, there are formed connection regions each laid out so as to be symmetrically rotated by 90 degrees to achieve connections among chips (inter-chip-connection), so that a plurality of chips can be stacked as rotated by 90 degrees to each other. Although not particularly limited, each connection region includes an analog or digital circuit having a predetermined property, such as a level converting circuit, a driving circuit, and an inductive coupled circuit which achieves a logical interface to the outside of the fundamental unit.

The connection regions 761-1 to 761-4 and 763-1 to 763-4 include one or more pieces of input/output connection means logically interfacing the configuration interfaces 752-1 to 752-4 and 751-1 to 751-4 of the fundamental unit, respectively. All of these connection regions are connected in parallel to each other, and arrangements of the input/output connection means are determined so as to enable the transmission of the configuration control signal also among the plurality of chips each relatively rotated.

The connection regions 762-1 to 762-4 and 764-1 to 764-4 include one or more pieces of input connection means and output connection means logically interfacing the external connection interfaces 755, 756, 754, and 753 of the fundamental unit, respectively, on the front and rear surfaces of the chip. Arrangements of the input connection means and output connection means in each connection region are determined so as to enable the transmission of the transaction also among the plurality of chips each relatively rotated.

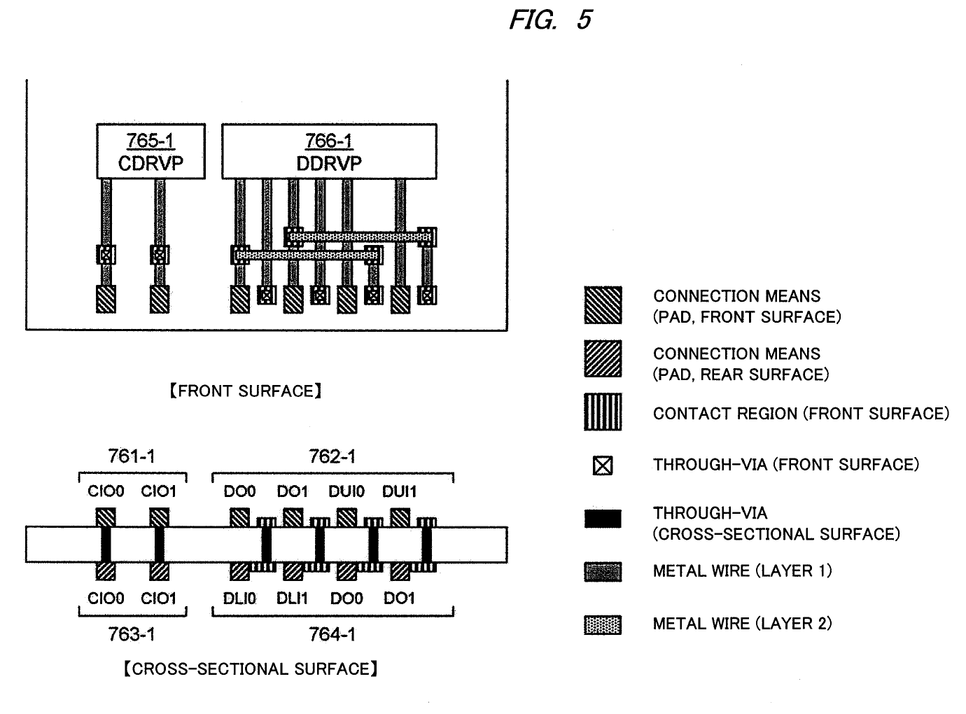

FIG. 5 illustrates a first embodiment of a connection region in a first side of the fundamental unit chip. In the present embodiment, usage of PAD by metal deposition is assumed as the connection means.

Both of CIO0 and CIO1 are the input/output connection means transmitting the configuration control signal, and the connection means between the front surface side 761-1 and the rear surface side 763-1 are connected in parallel through illustrated through-vias or logically connected inside a driving circuit 765-1 (CDRVP) interfacing the connection means although not illustrated.

DO0 and DO1, DUI0 and DUI1, and DLI0 and DLI1 are the output connection means from the chip, the input connection means from the front surface to the chip, and the input connection means from the rear surface to the chip, respectively, which transmit transactions. The output connection means between the front surface side 762-1 and the rear surface side 764-1 are connected in parallel through illustrated through-vias or logically connected in a driving circuit 766-1 (DDRVP) interfacing the connection means although not illustrated.

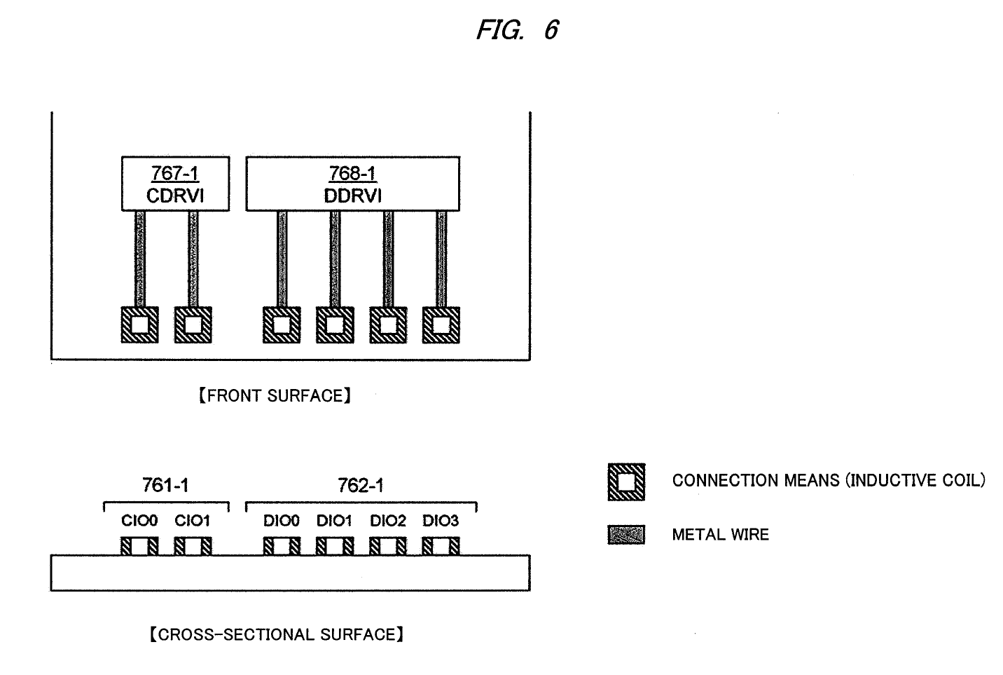

Further, FIG. 6 illustrates a second embodiment of the connection region on the first side of the fundamental unit chip. In the present embodiment, usage of magnetic coupling by inductive coils formed by metal wires is assumed as the connection means. Note that the magnetic coupling easily penetrates between the front and rear surfaces of the chip, and therefore, the inductive coils as the connection means are formed only on the front surface of the chip.

Both of CIO0 and CIO1 are the input/output connection means transmitting the configuration control signal, and are interfaced by a driving circuit 767-1 (CDRVI). DIO0, DIO1, DIO2, and DIO3 are the input/output connection means transmitting the transactions, and are interfaced by a driving circuit 768-1 (DDRVI).

Note that, in the communication using the magnetic coupling, broadcast of the transactions to all of the inductive coils formed on the plurality of chips and coaxially arranged is caused as far as its magnetic field reaches. Therefore, it is desired to provide arbitrating means among the plurality of chips in the driving circuit 768-1 or insert magnetic shield means for blocking the magnetic coupling among the chips if needed.

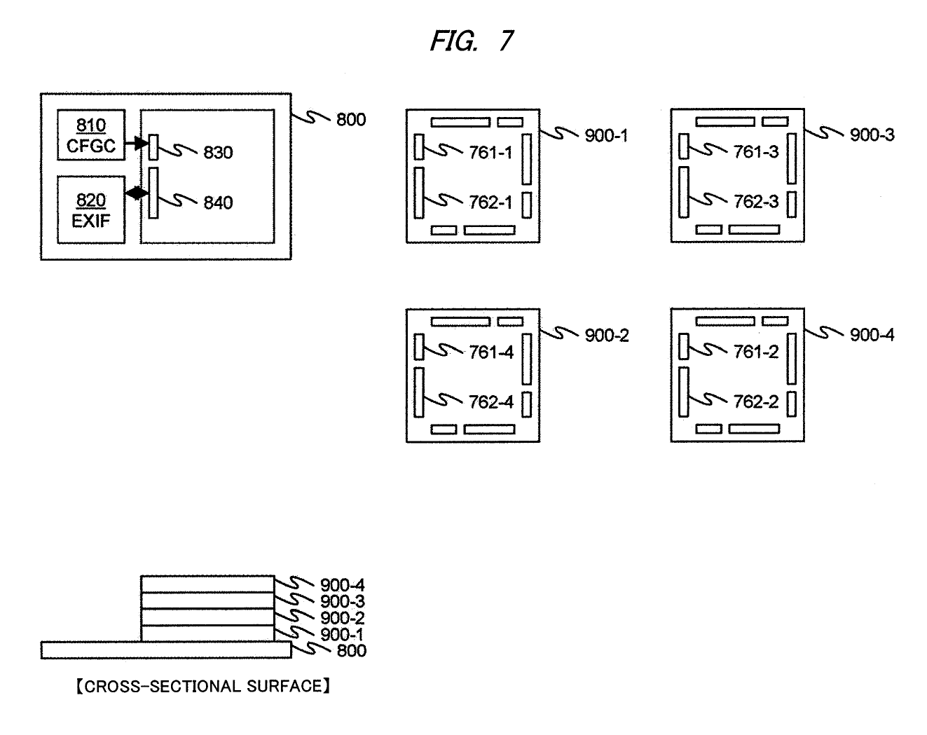

FIG. 7 illustrates a configuration example of a multiprocessor system including a plurality of fundamental unit chips. The multiprocessor system has single-type fundamental unit chips 900-1 to 900-4 arranged on a base chip 800 in a direction relatively rotated by 90 degrees from each other and three-dimensionally stacked.

The base chip 800 includes: a main configuration controlling unit 810 for controlling configurations of the fundamental unit chip group; an external interface 820 for controlling the connection with the outside of the base chip; and connection regions 830 and 840 for connecting the main configuration controlling unit 810 and the external interface 820 to the first fundamental unit chip 900-1.

As described above, according to the present invention, an embedded multiprocessor system having a desired computing performance and connection topology can be achieved at a low cost and in a short TAT without redesign, by combining single-type fundamental unit chips in which its processing contents and its connecting relations are properly configured.

What is claimed is:

1. A multi-chip processor configured by stacking a plurality of unit chips each having, at least, a processor core and a memory, wherein
the unit chip has: a plurality of processor cores; a plurality of memories; a configuration controlling unit setting a connection relation among the processor cores, the memories, and the outside of the chip; and a chip connecting unit transmitting transaction between the processor core, the memory chip, or the configuration controlling unit and the other stacked unit chips to be connected,
the chip connecting units are arranged on side portions of the unit chip so as to be rotationally symmetric to each other, and
any of the unit chips configured by stacking is rotationally connected.

2. The multi-chip processor according to claim 1, wherein
the chip connecting unit is configured with a first connecting unit transmitting transaction between the processor core or the memory and the outside of the chip and a second connecting unit transmitting transaction between the configuration controlling unit and the outside of the chip,
the first connecting unit is arranged on each side portion of the chips so as to transmit the transaction between the outside of the chip and any of the processor cores and the memories, and
the second connecting unit is arranged on the side portion so as to transmit transaction of the configuration controlling unit and the outside of the chip.

3. The multi-chip processor according to claim 2 further comprising a base chip having:
a main configuration controlling unit connected to the configuration controlling unit of the unit chip and performing configuration control of the plurality of unit chips; and
a chip connecting unit transmitting transaction between the main configuration controlling unit and the plurality of unit chips via the second connecting unit, wherein
the unit chips are stacked on the base chip.

4. The multi-chip processor according to claim 1, wherein
the chip connecting unit includes an inductive coupling circuit.

5. The multi-chip processor according to claim 4, wherein
the chip connecting unit has a shield unit blocking a coupling with a chip connecting unit of another stacked unit chip.

6. A multi-chip processor in which a part of or entire of the multi-chip processor is configured by stacking a plurality of semiconductor chips of, at least, single type to be processing components, wherein
the semiconductor chip has: connection means for achieving interconnection among chips; a configuration controlling unit retaining configuration information; and processor elements and bus arbitrating units capable of setting operation contents in accordance with configuration information outputted by the configuration controlling unit, and
the interchip connection means among chips are arranged so as to be rotationally symmetric to each other on the semiconductor chip.
